(19) United States
(12) Patent Application Publication
(10) Pub. No.: US 2007/0152597 A1
(43) Pub. Date: Jul. 5, 2007

(54) Process for manufacturing a high-intensity discharge lamp

(75) Inventors: Michel Paul Barbara Van Bruggen, Eindhoven (NL); Lucas Johannes Anna Maria Beckers, Eindhoven (NL); Saskia Brankaert, Uden (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/598,236

(22) PCT Filed: Feb. 25, 2005
(86) PCT No.: PCT/IB05/50700

§ 371 Date: Aug. 22, 2006

(30) Foreign Application Priority Data
Mar. 2, 2004 (EP) 04100824.4

(51) Int. Cl. H01J 61/35; H01J 17/16

(52) U.S. Cl. 313/635

(57) ABSTRACT

A process of manufacturing a high-intensity discharge lamp comprising an elongate ceramic discharge vessel surrounded by an outer envelope and having a wall which encloses a discharge space containing an inert gas, such as xenon, and an ionizable filling, wherein at both ends in said discharge space an electrode is arranged, between which electrodes a discharge arc can be maintained along a discharge path, with the special feature that, in order to improve the light transmission of the discharge vessel, said process comprises the step of placing the discharge vessel, in contact with a suspension of particles and allowing the suspension liquid to enter pores in said wall, thus coating the surface of said wall.

The present invention relates to a process of manufacturing a high-intensity discharge lamp comprising an elongate ceramic discharge vessel surrounded by an outer envelope and having a wall which encloses a discharge space containing an inert gas, such as xenon, and an ionizable filling, wherein at both ends in said discharge space an electrode is arranged, between which electrodes a discharge arc can be maintained along a discharge path. The invention also refers to a high-intensity discharge lamp manufactured according to this process.

Such a process and such a high-intensity discharge lamp are widely known.

The known high-intensity discharge lamp has a ceramic discharge vessel, that is a discharge vessel made of translucent polycrystalline Al₂O₃ (PCA) as a light-transmitting material. Such a discharge vessel is a complex shaped product often manufactured through conventional shaping techniques like slip casting, gel casting, or pressure casting. All these casting techniques have the disadvantage that the wall of the discharge vessel is considerably roughened during its release from the cast. Such a roughened wall has the effect that light is scattered at the surface of the wall. The scattering of light at the surface will hardly affect the total transmission (TT) of light of the discharge vessel. However, the total forward transmission (TFT) can be considerably lowered, while the real in-line transmission (RIT) of the discharge vessel is strongly deteriorated by such surface scattering. The surface of the wall of the discharge vessel is polished in order to minimize the above light-scattering effect as much as possible.

Light scattering also occurs at grain boundaries, pores, and so-called second-phase inclusions present in the wall of the discharge vessel, as described in an article entitled “Transparent alumina: a light-scattering model” (J. Am. Ceram. Soc., 86 (3) 480-486 (2003)) of the same inventor, which is included herein by reference. The quantities TFT, TT and RIT are measured as described in the said article. In particular the real in-line transmission (RIT) is measured over an angular aperture of at most 0.5° with a monochromatic wavelength of light. In order to obtain transparent instead of translucent PCA, the average grain size should be sufficiently small, pores should be avoided or sufficiently small, and second-phase inclusions should be absent or sufficiently small, as described in the cited J. Am. Ceram. Soc., 86 (3) 480-486 (2003) as well as in WO 04/007398, WO 04/007397 and EP 1 053983 A2.

It is an object of the invention to obviate this disadvantage of the prior art in the sense that the above-described light scattering is obviated without the use of a laborious polishing step.

In order to accomplish this objective, a process as described in the introduction of the description is characterized according to the invention in that, in order to improve the light transmission of the discharge vessel, said process comprises the step of placing the discharge vessel in contact with a suspension of inorganic particles and allowing the suspension to enter pores in said wall, thus coating the surface of said wall. Particularly, the suspension is applied to the surface of the discharge vessel in a dipping or spraying operation. In the dipping operation, the pre-sintered but still porous discharge vessel is dipped in a dilute dispersion of finely distributed inorganic particles, such that the liquid medium of the suspension, preferably water, is absorbed into the pores in the wall of the discharge vessel, giving rise to an accumulation of inorganic particles at the surface of the wall. The coating thus formed makes the initially rough surface smooth. The above-described procedure can be applied to ceramic discharge vessels made of translucent or transparent polycrystalline materials like Al₂O₃, YAG (Y₃Al₅O₁₂), Y₂O₃, AlON, PLZT's (Pb—La—Zr—Ti oxides), etc. The inorganic particles are preferably chosen from the group of Al₂O₃ particles, YAG (Y₃Al₅O₁₂) particles, Y₂O₃ particles, AlON particles, and PLZT (Pb—La—Zr—Ti oxides) particles.

In one preferred embodiment of a process in accordance with the invention, the coated discharge vessel is subsequently sintered in order to allow the coating to become an integral fused part of the ceramic wall of the discharge vessel. Preferably, sintering takes place at a sintering temperature varying between 1150 and 1500° C. A higher sintering temperature may lead to so-called thermal etching, that is the surface roughens due to transport of material away from the grain boundaries at the outside and inside of the discharge vessel.

In a further preferred embodiment of a process according to the invention, the inorganic particles are Al₂O₃ particles, wherein Al₂O₃ grains in the sintered material have an average grain size varying between 0.3 and 10 micron. The porosity is then virtually zero (<0.01%). This corresponds to values of the theoretical real in-line transmission of 80% with the average grain size being 0.3 micron, down to 6% in the case of the average grain size being 10 micron, taking the wall thickness of the vessel equal to 0.3 mm and the wavelength equal to 640 nm. The total forward transmission will be in all cases 86% if the surfaces are assumed to be sufficiently smooth so that no additional surface scattering will occur.

The invention also relates to a high-intensity discharge lamp comprising an elongate ceramic discharge vessel surrounded by an outer envelope and having a wall which encloses a discharge space containing an inert gas, such as xenon, and an ionizable filling, wherein at both ends in said discharge space an electrode is arranged, between which electrodes a discharge arc can be maintained along a discharge path. Such a known high-intensity discharge lamp is characterized according to the invention in that a coating of said inorganic particles forms an integral fused part of the ceramic wall of the discharge vessel, which integral fused part has a pore-filling effect such that the porosity of the finished ceramic wall of the discharge vessel is at least substantially below 0.01%.

In one preferred embodiment of a high-intensity discharge lamp in accordance with the invention, the integral fused part has a surface leveling and a smoothening effect such that the finished ceramic wall of the discharge vessel has a total transmission of more than 98%, the total forward transmission is more than 80%, and the real in-line transmission lies between 6% and 80% (for a wall thickness of 0.3 mm and a wavelength of 640 nm).

In a further preferred embodiment of a high-intensity discharge lamp according to the invention, said lamp is mounted in a lamp assembly for projection purposes. The latter lamp assembly particularly is a vehicle headlight or a beamer.

The above and further aspects of a high-intensity discharge lamp in accordance with the invention will now be explained with reference to a preferred embodiment shown in a drawing, wherein

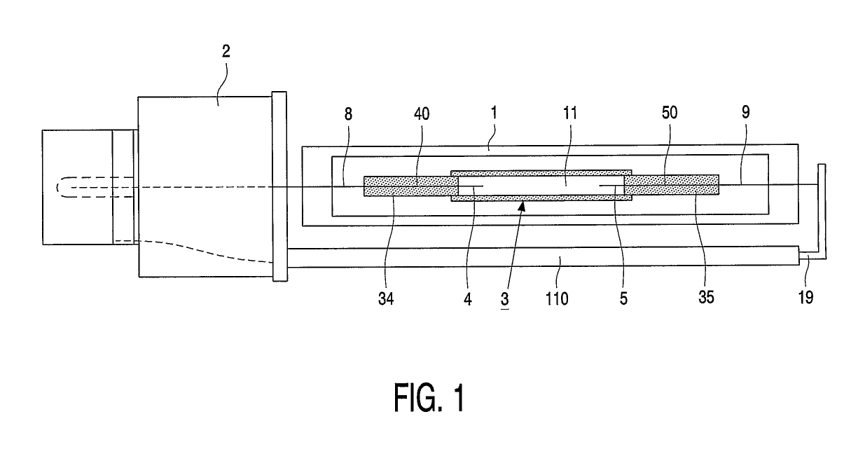

FIG. 1 shows a lamp according to the invention is side elevation; and

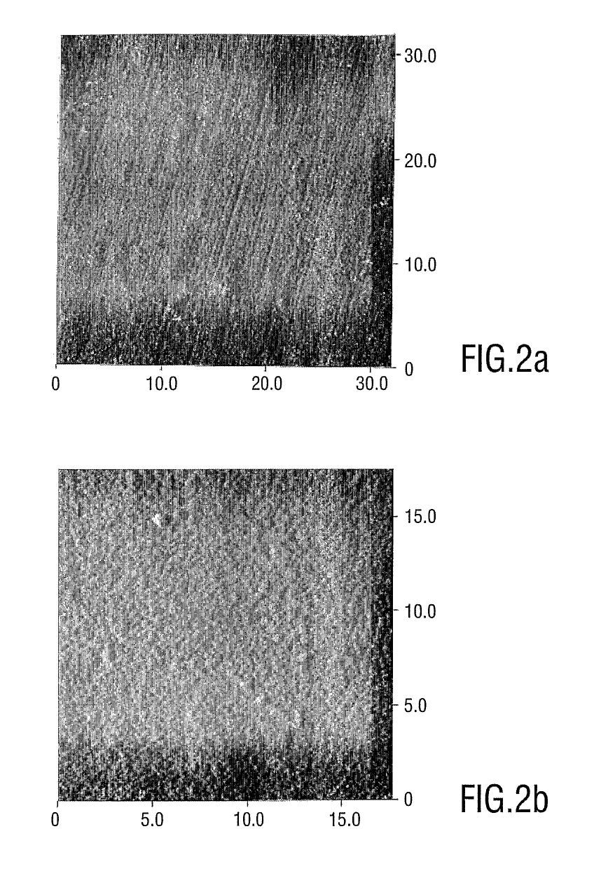

FIGS. 2a and 2b show microscopic upper views of the surface of the wall of the discharge vessel of the lamp shown in FIG. 1, polished according to the prior art (FIG. 2a) and dip-coated according to the invention (FIG. 2b), respectively.

In FIG. 1, the electric discharge lamp has a tubular, light transmissive ceramic discharge vessel 3 of polycrystalline aluminum oxide, and a first and a second current conductor 40, 50 which enter the discharge vessel 3 opposite each other. Each conductor 40, 50 supports an electrode 4, 5 in the vessel 3. Said electrodes are made of tungsten and are welded to the current conductors 40, 50.

Ceramic seals 34, 35 seal the discharge vessel 3 around the current conductors 40, 50 in a gastight manner. The discharge vessel 3 has an ionizable filling comprising xenon as a rare gas and a metal halide mixture comprising sodium and rare earth iodides. The discharge vessel 3 is surrounded by a substantially cylindrical transparent outer envelope 1.

The outer ends of current conductors 40, 50 are connected to connecting wires 8, 9 which extend outside the seals 34, 35 and through the end walls of outer envelope 1. One connecting wire 8 is connected directly to a first electric pole in mounting base 2, the other connecting wire 9 is connected to a return wire 19, which extends alongside the outer envelope 1 and is connected to a second electric pole in the mounting base 2. The return wire 19 is surrounded by a ceramic insulation shield 110.

A suspension consisting of 150 mm sized alpha-alumina particles (Taimei, TM-DAR) is deagglomerated by conventional techniques like wet ball milling or ultra-sonification and stabilized with a dispersant (e.g. nitric acid). The volume fraction of the suspension φₛ is taken to be 0.025. A complex shaped lamp envelope consisting of the same type of particles having a porosity p of 0.35 is calcinated at 600° C. in oxygen and immersed in the suspension with a volume fraction φ 5 . The wall thickness y of the envelope is 1 mm. The maximum achievable coating thickness d_{c} when the porosity of the coating is p_{c} is given by the formula:

$${d}_{c} = \frac{1 / 2 \cdot y \cdot p \cdot {ϕ}_{s}}{( 1 - {ϕ}_{s} ) ( 1 - {p}_{c} )} \qquad ( 1 )$$

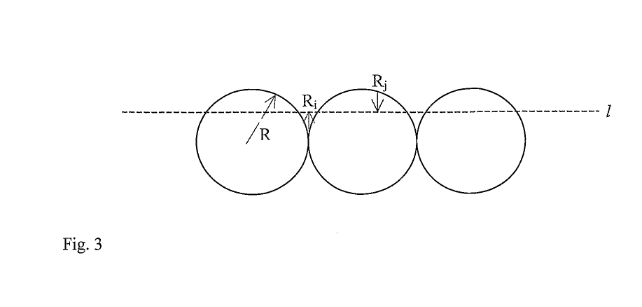

which is equal to 7 microns for the present case. The factor ½ in equation (1) stems from the fact that the envelope is coated at the outer side as well as on the inner side. By decreasing the dipping time, the coating thickness can be adjusted to any desirable value up to d_{c}. In the case of a thick coating d_{c} compared to the initial roughness R_{a,i} of the discharge vessel, the roughness is determined by the size of the spheres which in the unsintered state will be at least ⅛ D, where D is the size of the spheres. The roughness Rₐ is defined by:

$${R}_{a} = \frac{1}{n} {\sum }_{n} \vert {R}_{i} \vert , \qquad ( 2 )$$

where Rᵢ is the distance to the virtual center line l in some location i at the coated surface, as indicated in the Figure below (FIG. 3).

The lamp envelope with the coating is sintered at 1200° C. to a density of 99% without cracking or delamination of the coating. The final densification is achieved by hot isostatic pressing at 1200° C., for 12 hours at 200 MPa of argon. At a sintering temperature of 1200° C., thermal etching of the grain boundaries does not give rise to roughening of the surface to such an extent that is causes diffuse light scattering. The bodies have become transparent after HIP, as the small average grain size (˜0.5 micron) combined with the high surface smoothness leads to a very significant suppression of the light scattering.

FIGS. 2a and 2b show pictures taken with the help of an atomic microscope, wherein picture 2a is an upper view of a polished surface of a wall of a sintered discharge vessel (prior art), and picture 2b is an upper view of a dip-coated sintered surface of a wall of a discharge vessel obtained according to the invention as described above. The Rₐ of the polished surface is about 7 nm, whereas the dipcoated surface is characterized by an Rₐ of 9 nm.

1. A process of manufacturing a high-intensity discharge lamp comprising an elongate ceramic discharge vessel surrounded by an outer envelope and having a wall which encloses a discharge space containing an inert gas, such as xenon, and an ionizable filling, wherein at both ends in said discharge space an electrode is arranged, between which electrodes a discharge arc can be maintained along a discharge path, characterized in that, in order to improve light transmission of the discharge vessel, said process comprises the step of placing the discharge vessel in contact with a suspension of inorganic particles and allowing the suspension to enter pores in said wall, thus coating the surface of said wall.

2. A process according to claim 1, wherein the suspension is applied to the surface of the discharge vessel in a dipping or spraying operation.

3. A process according to claim 1, wherein the coated discharge vessel is subsequently sintered in order to allow the coating to become an integral fused part of the ceramic wall of the discharge vessel.

4. A process according to claim 3, wherein the coated discharge vessel is sintered at a sintering temperature varying between 1150 and 1500° C.

5. A process according to claim 4, wherein the inorganic particles are Al₂O₃ particles, and wherein Al₂O₃ grains in the sintered material have an average grain size varying between 0.3 and 10 microns (μm)

6. A high-intensity discharge lamp comprising an elongate ceramic discharge vessel surrounded by an outer envelope and having a wall which encloses a discharge space containing an inert gas, such as xenon, and an ionizable filling, wherein at both ends in said discharge space an electrode is arranged, between which electrodes a discharge arc can be maintained along a discharge path, characterized in that a coating of inorganic particles is made an integral fused part of the ceramic wall of the discharge vessel, which integral fused part has a pore-filling effect such that the porosity of the finished ceramic wall of the discharge vessel is at least substantially smaller than 0.01%.

7. A high-intensity discharge lamp according to claim 6, wherein the integral fused part has a surface leveling and a smoothening effect such that the finished ceramic wall of the discharge vessel has a total transmission of more than 98%, the total forward transmission is above 80%, and the real in-line transmission lies between 6% and 80% (for a wall thickness of 0.3 mm and a wavelength of 640 nm).

8. A high-intensity discharge lamp according to claim 6, wherein said lamp is mounted in a lamp assembly for projection purposes.

9. A high-intensity discharge lamp according to claim 8, wherein said lamp is mounted in a vehicle headlight.

10. A high-intensity discharge lamp according to claim 8, wherein said lamp is mounted in a beamer.
